(19) United States
(12) Patent Application Publication
(10) Pub. No.: US 2007/0222632 A1
(43) Pub. Date: Sep. 27, 2007

(54) Monitoring device and associated system and method

(75) Inventor: Yu-Wen Chang, Rancho Palos Verdes, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Chang Industry, Inc.

(21) Appl. No.: 11/386,042

(22) Filed: Mar. 21, 2006

(51) Int. Cl. G08B 23/00; H04B 1/034; G08B 3/00

(52) U.S. Cl. 340/693.9; 455/96; 340/691.1

(57) ABSTRACT

A monitoring device is provided, comprising a monitoring element configured to provide a monitoring indicia, and a plurality of flexible elongate securing members operably engaged with the monitoring element and adapted to secure the monitoring element to a monitored object. Each securing member has a proximal end secured to and extending from the monitoring element to an opposed unsupported distal end. The securing members are configured such that at least a medial portion of one of the securing members, between the proximal and distal ends thereof, is capable of forming a securing engagement with the monitored object to secure the monitoring element thereto such that the monitoring indicia identifies the monitored object. An associated system and method are also provided.

### BACKGROUND OF THE INVENTION

1. Field of the Invention

The present invention relates to the remote monitoring of an object and, more particularly, to a selectively deployable monitoring device and associated system and method.

2. Description of Related Art

A high speed chase, in which a suspect in a vehicle is fleeing from law enforcement, is an all too common and very dangerous occurrence. Many times, the fleeing vehicle is pursued from the air, such as by a helicopter, and from the ground by one or more police cars. However, the pressure of the pursuit often causes the suspect to drive erratically and at a high rate of speed, thereby possibly resulting in injury to innocent bystanders, damage to other vehicles or property, and/or loss of life. Such pursuits are also hazardous to the pursuing law enforcement officers as well as costly, often requiring significant police manpower, equipment, and time. In some instances, the commuting public may be significantly inconvenienced by traffic delays caused by such incidents. Accordingly, certain jurisdictions have enacted regulations for restricting such police chases under certain conditions. However, such a solution has the negative effect of allowing the suspect to escape if conditions exist which cause the police to terminate the chase. Further, instead of pursuing the suspect, other manners of halting the suspect's vehicle have been developed such as, for example, spike strips. However, just like roadblocks, such measures typically require law enforcement to correctly anticipate the direction in which the suspect will flee, and thus may not often be successful in halting the suspect.

In many instances, on the other hand, if the fleeing suspect perceives the ability of escaping without being followed by law enforcement, the suspect may tend to drive normally so as to escape detection, thereby reducing the risk of damage, injury and/or death. Thus, there exists a need for a method, apparatus, and/or system capable of effectively tracking or otherwise monitoring a fleeing suspect in such a manner that the risks and costs of a high speed pursuit are reduced and/or minimized.

### BRIEF SUMMARY OF THE INVENTION

The above and other needs are met by the present invention which, in one embodiment, provides a monitoring device adapted to monitor a monitored object. Such a device includes a monitoring element configured to provide a monitoring indicia. A plurality of flexible elongate securing members is operably engaged with the monitoring element and the securing members are adapted to secure the monitoring element to a monitored object. Each securing member has a proximal end secured to and extending from the monitoring element to an opposed unsupported distal end. The securing members are configured such that at least a medial portion of one of the securing members, between the proximal and distal ends thereof, is capable of forming a securing engagement with the monitored object to secure the monitoring element thereto such that the monitoring indicia identifies the monitored object.

Another advantageous aspect of the present invention comprises a system adapted to monitor a monitored object. Such a system includes a monitoring device, comprising a monitoring element configured to provide a monitoring indicia. A plurality of flexible elongate securing members is operably engaged with the monitoring element and the securing members are adapted to secure the monitoring element to a monitored object. Each securing member has a proximal end secured to and extending from the monitoring element to an opposed unsupported distal end. The securing members are configured such that at least a medial portion of one of the securing members, between the proximal and distal ends thereof, is capable of forming a securing engagement with the monitored object. The system also includes a deployment vehicle configured to be capable of deploying the monitoring device onto the monitored object such the at least a medial portion of one of the securing members secures the monitoring element to the monitored object and such that the monitoring device identifies the monitored object via the monitoring indicia.

Still another advantageous aspect of the present invention comprises a method of monitoring a monitored object. Such a method includes deploying a monitoring device from a deployment vehicle onto a monitored object. The monitoring device comprises a monitoring element and a plurality of flexible elongate securing members operably engaged with the monitoring element. The monitoring element is secured to the monitored object with at least one of the securing members, wherein each securing member has a proximal end secured to and extending from the monitoring element to an opposed unsupported distal end. The monitoring element is secured to the monitored object with at least one of the securing members such that at least a medial portion of the at least one of the securing members, between the proximal and distal ends thereof, is in securing engagement with the monitored object. A monitoring indicia is provided with the monitoring element so as to allow the monitored object to be monitored.

Thus, advantageous embodiments of the present invention provide distinct advantages as further detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a cross-sectional schematic of a monitoring device, according to one embodiment of the present invention;

FIG. 2 is a schematic of a system for monitoring a monitored object, according to one embodiment of the present invention, illustrating a monitoring device being deployed from various deployment vehicles toward the monitored object to be monitored;

FIG. 3 is a schematic of a monitoring device, according to one embodiment of the present invention, illustrating a launching device configured to cooperate therewith to launch a monitoring device; and

FIGS. 4-6 are schematics illustrating a deployment sequence of a monitoring device, according to one embodiment of the present invention, wherein the monitoring device is launched toward and engages a monitored object by at least a portion a securing member secured to and extending from a monitoring element of the monitoring device.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

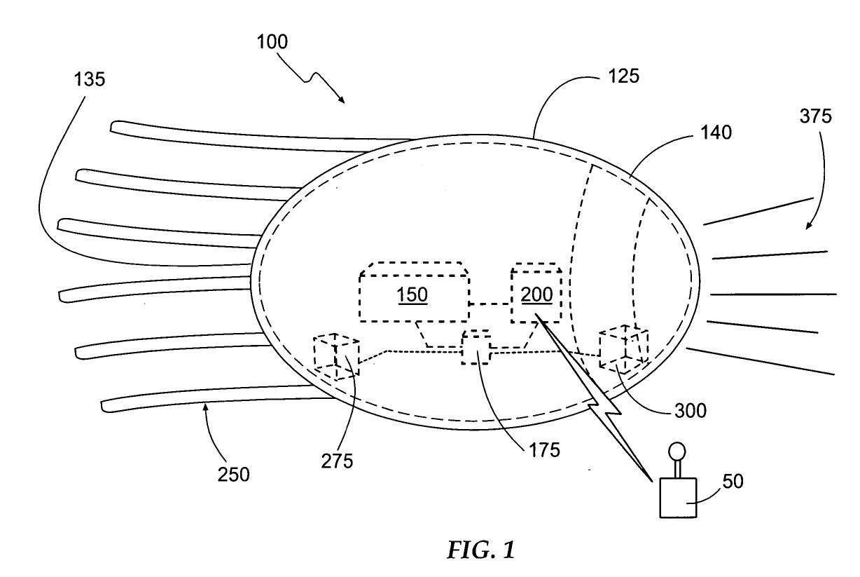

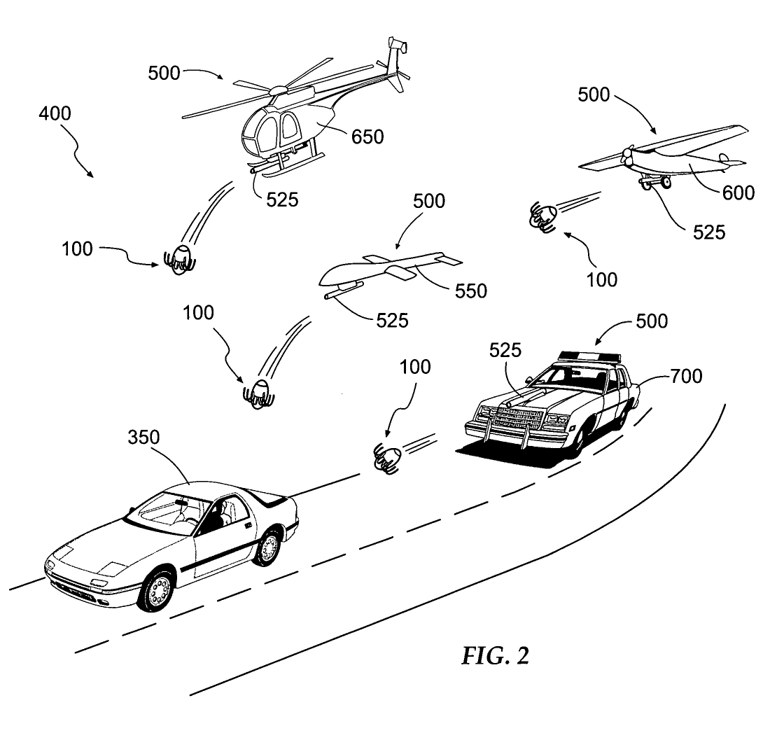

FIG. 1 schematically illustrates a monitoring device according to one embodiment of the present invention and as used in a system as shown in FIG. 2, the monitoring device being indicated generally by the numeral 100. The monitoring device 100 comprises a monitoring element 125 having a plurality of flexible elongate securing members 250 engaged therewith. The securing members 250 are configured to secure the monitoring element 125 to an object 350 to be monitored. Once secured to the monitored object 350, the monitoring element 125 is configured to provide a monitoring indicia 375 through which the monitored object 350 is monitored. The monitoring indicia 375 may comprise, for example, a luminescent material associate with the monitoring element 125, a distinctive color or distinctively colored material associated with the monitoring element 125, a light emitter such as a light-emitting diode or strobe light operably engaged with the monitoring element 125, and/or a sound emitter operably engaged with the monitoring element 125. In other instances, the monitoring element 125 may include a location signal emitter, a light reflector, a sound reflector, and/or a radar reflector associated therewith. One skilled in the art will appreciate, however, that the monitoring element 125 may include many different configurations of a monitoring indicia 375 consistent with the spirit and scope of the present invention, and that the various forms of a monitoring indicia 375 disclosed herein are for exemplary purposes only and are not intended to be limiting in any manner.

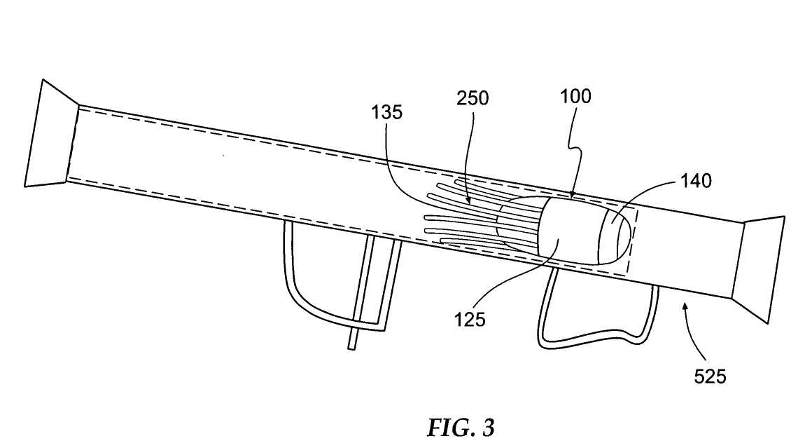

In particular embodiments, the monitoring device 100 is configured to be launched or deployed, via a launching device 525 as shown in FIGS. 2 and 3, toward the monitored object 350 from a remote and discrete location with respect thereto. In such instances, the monitoring device 100 is appropriately configured as a projectile capable of being launched or deployed from a suitable distance and proceeding in aerodynamic flight toward the monitored object 350. For example, the monitoring element 125 may be configured in the shape of a bullet or missile, or any other shape suitable for purposes of flight toward the monitored object 350. With the monitoring element 125 thus configured, the securing members 250 are configured to operably engage the monitoring element 125 so as to be deployed into engagement with the monitored object 350 when the monitoring element 125 strikes or otherwise engages the monitored object 350. For example, the monitoring element 125 may comprise an elongate body having a forward end 135 and a rearward end 140. The cross-section of the monitoring element 125 may be, for example, circular, oval, or any other suitable shape. In one embodiment, the securing members 250 are disposed around the perimeter defined by the cross-section of the monitoring element 125. The securing members 250 may be evenly or unevenly spaced about the perimeter, as necessary. Further, in some embodiments, the securing members 250 are disposed about the forward end 135 of the monitoring element 125, or medially with respect to the monitoring element 125, but toward the forward end 135 thereof. The securing members 250 may be secured to the monitoring element 125 so as to normally extend toward the forward end 135, perpendicularly with respect to the monitoring element 125, or toward the rearward end 135, as necessary and/or desired.

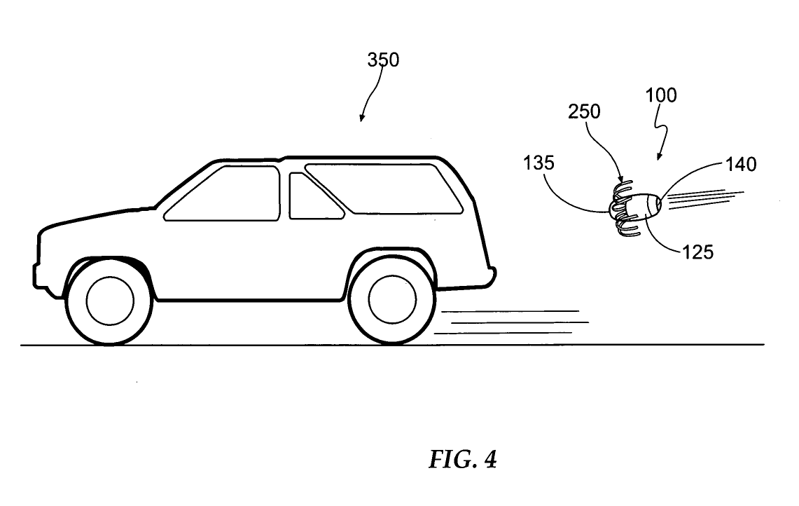

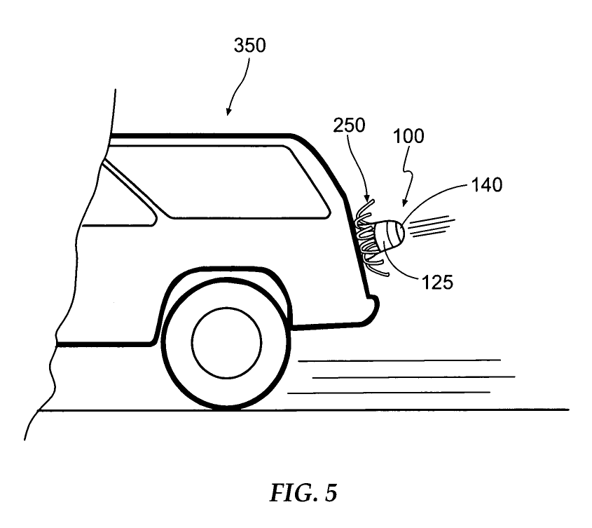

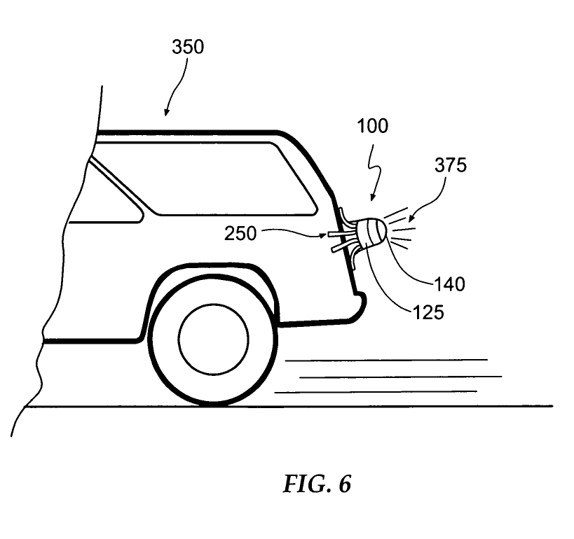

A monitoring device 100 comprising an aerodynamic projectile capable of being launched or deployed from a launching device 525, as previously discussed, is also configured to be projected toward and interact with the monitored object 350 in a particular manner. For example, as shown in FIGS. 4-6, the monitoring device 100 is configured such that, following the launch thereof from the launching device 525 and during the projection or flight of the monitoring device 100 toward the monitored object 350, the flexible and elongate securing members 250 extend along the monitoring element 125 such that the distal ends of the securing members 250 (the unsupported ends of the securing members 250 not secured to the monitoring element 125) are disposed toward the rearward end 140 of the monitoring element 125 (see, e.g., FIG. 4). In such a configuration, the elongate securing members 250 may also contribute to the aerodynamic nature of the monitoring device 100. Upon the monitoring device 100 striking or otherwise contacting the monitored object 350, the securing members 250 are further configured to pivot about the attachment point thereof to the monitoring element 125 such that the distal ends and/or at least a part of the medial portions (between the distal and proximal ends) of the securing elements 250 contact the monitored object 350 radially outward of the monitoring element 250 (see e.g., FIGS. 5 and 6). That is, the momentum caused by the impact or contact of the forward end 135 of the monitoring element 125 with the monitored object 350 causes the unsupported distal ends of the securing members 250 to continue traveling toward the monitored object 350, while the flexible nature of the securing members 250 caused the distal ends to pivot about the attachment points of the proximal ends of the securing members 250 to the monitoring element 125 until the distal ends and/or at least a part of medial portions of the securing members 250 contact the monitored object 350. In some embodiments, the forward end 135 of the monitoring element 125 is configured to be soft or otherwise resilient so as to minimize any damage to the monitored object 350, while causing the securing members 250 to pivot about the attachment points thereof to the monitoring element 125, as discussed herein.

In some embodiments, the securing elements 250, as previously discussed, are attached to or otherwise operably engaged with the monitoring element 125, wherein the securing elements 250 are further configured to attach or otherwise secure the monitoring element 125 to the monitored element 350. Such a monitored element 350 may comprise, for example, a vehicle driven by a suspect fleeing from law enforcement officers. However, in other instances, depending on the particular features or aspects included with the monitoring device 100, the monitored object 350 may be different under different scenarios. For example, should the monitoring element 125 include an audio device 275 and/or a video device 300 for capturing audio and/or video signals, as discussed further herein, the monitored object 350 may comprise a wall of a building or compound providing a surveillance point of a particular scene. Should the audio device 275 and/or video device 300 also be capable of broadcasting an audio and/or video signal so as to allow 2-way communication, the monitored object 350 may comprise any object within proximity of a hostage situation. Accordingly, one skilled in the art will appreciate that embodiments of the monitoring device 100 disclosed herein may be applied in many different scenarios where the nature of the monitored object 350 may vary considerably, and that the discussion of a monitored object herein is for exemplary purposes only is not intended to be limiting in any manner.

The securing elements 250 may be comprised of, for example, a rubber or polymeric material appropriate for achieving the necessary flexibility thereof. The securing elements 250 may also comprise a magnetic material or substance configured to magnetically attach the monitoring element 125 to the monitored object 350. The magnetic material or substance is incorporated into the securing members 250 and the monitoring element 125 further configured such that the magnetic substance does not interfere with the operation of any electronic devices, as discussed herein, that may also be included with the monitoring device 100. In other instances, the securing elements 250 may comprise, for example, an adhesive material or substance for attaching the monitoring element 125 to the monitored object 350, in addition to or in place of the magnetic substance. Such an adhesive substance may, for example, be permanent or nonremovable, require a particular solvent for removal thereof, or otherwise be temporary, wherein a temporary adhesive substance may require, for instance, a certain removal force to be applied thereto or a particular extent of environmental degradation to occur, in order to allow the securing elements 250 to be removed from the monitored object 350. The use of a magnetic substance in addition to an adhesive substance may provide an advantage in instances when, for example, water, dirt, dust, or other substances present on a metallic body of a vehicle may prevent the adhesive substance from making a suitable bond therewith. As such, the magnetic substance may be able to provide the necessary securing force with the vehicle. In addition, the plurality of securing members 250 increases the likelihood of the monitoring device 100 being sufficiently secured to the monitored object 350 upon deployment. That is, it may be sufficient for a distal portion and/or at least a part of the medial portion of one of the securing members 250 to form a securing engagement with the monitored object 350 for the monitoring device 100 to be appropriately secured thereto or performing one or more of the functions disclosed herein. One skilled in the art will also appreciate that the magnetic material/substance and/or the adhesive material/substance may also be associated with the forward end 135 of the monitoring element 125, as necessary or desired, so as to further the likelihood of the monitoring device 100 being sufficiently secured to the monitored object 350 upon deployment.

Once deployed and secured to the monitored object 350, the monitoring device 100 is further configured to provide a monitoring indicia 375 by which the monitored object 350 can be monitored. As previously discussed, such a monitoring indicia 375 may comprise, for example, a luminescent material associate with the monitoring element 125, a distinctive color or distinctively colored material associated with the monitoring element 125, a light emitter such as a light-emitting diode or strobe light operably engaged with the monitoring element 125, and/or a sound emitter operably engaged with the monitoring element 125. In other instances, the monitoring element 125 may include a location signal emitter, a light reflector, a sound reflector, and/or a radar reflector associated therewith. As indicated, the monitoring indicia 375 thus allows the monitored object 350 to be monitored visually, aurally, or via electronic components. As such, the monitoring device 100 may be appropriately configured for a particular situation while considering other factors such as cost or relative stealth, for example. As such, in a car chase scenario, the monitoring device 100 may be configured to emit a location signal such that the car can be remotely tracked. However, if visual surveillance of a vehicle is preferred, the monitoring indicia 375 may comprise a light emitter or a distinctive color so as to indicate the identity of the vehicle to the persons performing the surveillance. Accordingly, one skilled in the art will further appreciate that the monitoring indicia 375 provided by the monitoring element 125 may be active or passive, or a combination of both active and passive as required, and that the configurations of such a monitoring indicia 375 presented herein are for exemplary purposes only and are not intended to be limiting in any manner.

In some particular embodiments, the monitoring device 100 may include a location-determining device 150 and a signaling device 200 housed by or otherwise engaged with the monitoring element 125. That is, in some instances, the monitoring element 125 may comprise a housing for containing the location-determining device 150 and the signaling device 200. The location-determining device 150 may comprise, for example, a Global Positioning System (GPS) device or other suitable device capable of determining a location of the monitoring device 100, whereby the location of the monitoring device 100, whether mobile or stationary, can then be monitored by a station 50 disposed remotely thereto, as described further herein. Such a location may be determined, for example, as a set of geodetic coordinates indicating a particular latitude and longitude. The signaling device 200 is in communication or otherwise operably engaged with the location-determining device 150, wherein the signaling device 200 may comprise, for example, a transmitter device or a transceiver device, as will be appreciated by one skilled in the art. That is, the signaling device 200 is configured to receive the location determined by the location-determining device 150 and to at least transmit a location signal corresponding to the location to the station 50, wherein the station 50 may be mobile or stationary, so as to allow the location of the monitoring device 100 to be remotely tracked or otherwise monitored. The communication between the signaling device 200 and the remote station 50 may be accomplished over a wireless link, as will be appreciated by one skilled in the art, though, in some instances, the signaling device 200 may also be configured to be in communication with the station 50 via a wireline communication link as an alternative or in addition to the wireless link.

According to some embodiments of the present invention, the location-determining device 150 and the signaling device 200 may be housed in or otherwise associated with the monitoring element 125. In some instances, the monitoring element 125 is configured to be, for example, compact, wear resistant, impact resistant, moisture resistant, and/or configured such that the location-determining device 150 and/or the signaling device 200 may be mounted therein so as to be protected thereby. The monitoring element 125, in some embodiments and as shown, may be an aerodynamically shaped projectile capable of being launched toward the monitored object 350, though one skilled in the art will appreciate that many different shapes of such a monitoring element 125 are within the spirit and scope of the present invention. In addition, the monitoring device 100 may further comprise a power source 175 in operative engagement with the location-determining device 150 and/or the signaling device 200 for providing the necessary electrical power for allowing the respective electronic components (or other electronic components included with the monitoring device 100) to be operable, wherein such a power supply 175 may comprise, for example, a battery, solar cell, or the like, as will be appreciated by one skilled in the art.

Other embodiments of the present invention may include, for example, an audio device 275 and/or a video device 300 (shown in phantom in FIG. 1) operably engaged with the monitoring device 100. In instances where a monitoring element 125 is implemented, the audio and/or video devices 275, 300 may be contained within the monitoring element 125, attached thereto, or otherwise integrated therewith. When implemented, the audio and video devices 275, 300 are capable of capturing audio and video signals, respectively. In such instances, the signaling device 200, as well as the power source 175, may also be in communication with or otherwise operably engaged with the audio and/or video devices 275, 300 and configured to transmit the audio and/or video signal, respectively, to the station 50 such that sounds and images about the monitoring device 100 may also be remotely monitored. In other instances, the signaling device 200 may be configured to receive a signal from the station 50. For example, the audio and video devices 275, 300 may be configured to be capable of broadcasting an audio and a video signal, respectively. In such instances, for example, a voice warning or visual indicia may be broadcast from the remote station 50 and through the monitoring device 100 via the signaling device 200 and the audio and/or video devices 275, 300. Accordingly, such configurations would allow two-way audio and/or video communication between the monitoring device 100 and the remote station 50.

Another advantageous aspect of the present invention comprises a system for monitoring a monitored object 350 as shown in FIGS. 2-4, the system being indicated by the numeral 400. Such a system 400 comprises a monitoring device 100, as previously described, and a deployment vehicle 500. Such a deployment vehicle 500 may comprise, for example, an unmanned aerial vehicle (UAV) 550 or a manned aerial vehicle such as, for instance, an airplane 600 or a helicopter 650. In other instances, the deployment vehicle 500 may comprise a ground vehicle (not shown) such as a car, truck or motorcycle, or a waterborne vehicle (not shown) if the tracking function is accomplished on the water. Accordingly, the deployment vehicle 500 is configured to selectively deploy the monitoring device 100, where necessary, onto the monitored object 350 via an appropriate launching device 525 to as to allow the monitored object 350 to be remotely tracked or otherwise monitored from the station 50 or from in close proximity to the monitored object 350.

The selective deployment of the monitoring device 100 from the deployment vehicle 500 may be accomplished in many different manners, as will be appreciated by one skilled in the art and within the spirit and scope of the present invention. For example, the monitoring device 100 may be configured to be deployed via the launching device 525 or dropped from the deployment vehicle 500 onto the monitored object 350 to be monitored, wherein the securing elements 250 may further be configured to be capable of attaching the monitoring device 100 to the monitored object 350 regardless of the orientation or velocity at which the monitoring device 100 contacts the monitored object 350. In other instances, the monitoring device 100 may be configured, for example, to be self-propelled when deployed by the deployment vehicle 500 or, as previously discussed, the deployment vehicle 500 may be equipped with a launching device 525 capable of launching and propelling the monitoring device 100 toward and into engagement with the monitored object 350 so as to allow the securing elements 250 to attach the monitoring device 100 thereto. Further, the securing elements 250, in those instances, may also be configured so as to be capable of attaching the monitoring device 100 to the monitored object 350 as appropriate with respect to the orientation, speed, direction, or other parameters with which the monitoring device 100 is deployed toward the monitored object 350 by the deployment vehicle 500. One skilled in the art will also appreciate that the manner in which the monitoring device 100 is deployed by the deployment vehicle 500 should be sufficiently accurate so as to maximize the probability that the monitoring device 100 will be effectively attached to the monitored object 350. Accordingly, where necessary, the monitoring device 100, deployment vehicle 500, and/or launching device 525 may include an appropriate aiming or guide device (not shown) for directing the monitoring device 100 to the monitored object 350.

According to embodiments of the present invention, the station 50 may comprise, for example, a stationary remote site such as a monitoring station in a building, or the station 50 may be incorporated into any of the deployment vehicles 500 or other designated vehicles. In other instances, the station 50 may comprise a portable device which may be transported by a designated person. Further, any of the stations 50 may be, in some instances, configured to relay the location signal to other stations 50, as necessary. In addition, communication between the monitoring device(s) 100 and the station(s) 50, or between stations 50 may be accomplished via, for example, a satellite, if the need exists. One skilled in the art will appreciate, however, that such system 400 may comprise one or more such monitoring devices 100 where all such monitoring devices 100 may be monitored from one or more stations 50. Accordingly, in some instances, the monitoring device(s) 100 and/or the associated station(s) 50 may be provided with, for example, an appropriate identification code, which may also be monitored so as to allow discrimination between or indicate the particular monitoring device(s) 100 being tracked, as will also be appreciated by one skilled in the art.

Thus, embodiments of the present invention allow, for example, a fleeing suspect in a vehicle to be remotely tracked, thereby obviating the need for a close pursuit by law enforcement while still providing for the suspect's location and movement to be monitored. In some instances, other methods for stopping the suspect such as spike strips and roadblocks may be more successful. In other instances, the suspect, without the pressure of a hot pursuit by law enforcement, may tend to drive more normally, thereby lessening the risk of damage, injury, and/or death as a result of such a chase. Still further, law enforcement resources may be allocated more efficiently toward apprehending the suspect, while inconvenience and risk to the public is decreased. In other situations, embodiments of the present invention may allow an object to be identified via the monitoring device 100, or otherwise allow a scene to be remotely monitored or have 2-way communication implemented therewith by the deployment of the monitoring device 100.

Many modifications and other embodiments of the invention set forth herein will come to mind to one skilled in the art to which this invention pertain having the benefit of the teachings presented in the foregoing descriptions and the associated drawings. For example, one skilled in the art will appreciate from the foregoing that an additional embodiment of the present invention may comprise a method for monitoring a monitored object 350. More particularly, such a method would include deploying a monitoring device 100 from a deployment vehicle 500 onto a monitored object 350, with the monitoring device 100 comprising a monitoring element 125 and a plurality of flexible elongate securing members 250 operably engaged with the monitoring element 125. The monitoring element 125 is then secured to the monitored object 350 with at least one of the securing members 250, wherein each securing member 250 has a proximal end secured to and extending from the monitoring element 125 to an opposed unsupported distal end. The monitoring element 125 is secured to the monitored object 350 with at least one of the securing members 250 such that at least a medial portion of the at least one of the securing members 250, between the proximal and distal ends thereof, is in securing engagement with the monitored object 350. A monitoring indicia 375 is thereafter provided with the monitoring element 125 so as to allow the monitored object 350 to be monitored. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A monitoring device, comprising:
a monitoring element configured to provide a monitoring indicia; and
a plurality of flexible elongate securing members operably engaged with the monitoring element and adapted to secure the monitoring element to a monitored object, each securing member having a proximal end secured to and extending from the monitoring element to an opposed unsupported distal end, the securing members being configured such that at least a medial portion of one of the securing members, between the proximal and distal ends thereof, is capable of forming a securing engagement with the monitored object to secure the monitoring element thereto such that the monitoring indicia identifies the monitored object.

2. A monitoring device according to claim 1 wherein each securing member comprises at least one of an adhesive substance and a magnetic substance.

3. A monitoring device according to claim 1 wherein the monitoring indicia comprises at least one of a light emitter, a luminescent material, a distinctively colored material, a sound emitter, a location signal emitter, a light reflector, a sound reflector, and a radar reflector.

4. A monitoring device according to claim 1 further comprising a location-determining device operably engaged with the monitoring element and configured to be capable of determining a location.

5. A monitoring device according to claim 4 further comprising a signaling device operably engaged with the location-determining device and configured to be capable of transmitting a signal, including a location signal corresponding to the location determined by the location-determining device, to a station remotely disposed with respect to the location-determining device.

6. A monitoring device according to claim 5 wherein the monitoring element further comprises a housing configured to house the location-determining device and the signaling device.

7. A monitoring device according to claim 1 wherein the monitoring element is configured to be deployable onto the monitored object from a remote location discrete with respect to the monitored object.

8. A monitoring device according to claim 1 wherein the monitoring element is further configured as a projectile having a forward end and a rearward end relative to a deployment direction, and the securing members are operably engaged with the monitoring element about the forward end thereof such that, upon deployment of the monitoring element, the unsupported distal ends of the securing members extend toward the rearward end of the monitoring element and such that, upon the forward end of the monitoring element contacting the monitored object, the unsupported distal ends of the securing members pivot about the proximal ends thereof and toward the monitored object such that the at least a medial portion of one of the securing members securingly engages the monitored object and secures the monitoring element thereto.

9. A monitoring device according to claim 4 wherein the location-determining device further comprises a Global Positioning System (GPS) device.

10. A monitoring device according to claim 5 further comprising at least one of an audio device capable of capturing an audio signal and a video device capable of capturing a video signal, the at least one of the audio and the video devices being operably engaged with the monitoring element and with the signaling device, wherein the signaling device is configured to be capable of transmitting at least one of the audio and the video signals.

11. A monitoring device according to claim 5 wherein the signaling device is further configured to be capable of receiving a signal from the station, and the monitoring device further comprises at least one of an audio device capable of broadcasting an audio signal and a video device capable of broadcasting a video signal, the at least one of the audio and the video devices being operably engaged with the monitoring element and capable of broadcasting the respective audio and video signals in response to the signal received from the station via the signaling device.

12. A monitoring device according to claim 5 wherein the signaling device is configured to be capable of communicating with the station by way of at least one of a wireless and a wireline communication system.

13. A system adapted to monitor a monitored object, said system comprising:
a monitoring device, comprising:
a monitoring element configured to provide a monitoring indicia; and
a plurality of flexible elongate securing members operably engaged with the monitoring element and adapted to secure the monitoring element to a monitored object, each securing member having a proximal end secured to and extending from the monitoring element to an opposed unsupported distal end, the securing members being configured such that at least a medial portion of one of the securing members, between the proximal and distal ends thereof, is capable of forming a securing engagement with the monitored object; and
a deployment vehicle configured to be capable of deploying the monitoring device onto the monitored object such the at least a medial portion of one of the securing members secures the monitoring element to the monitored object and the monitoring device identifies the monitored object via the monitoring indicia.

14. A system according to claim 13 wherein each securing member comprises at least one of an adhesive substance and a magnetic substance.

15. A system according to claim 13 wherein the monitoring indicia comprises at least one of a light emitter, a luminescent material, a distinctively colored material, a sound emitter, a location signal emitter, a light reflector, a sound reflector, and a radar reflector.

16. A system according to claim 13 further comprising a location-determining device operably engaged with the monitoring element and configured to be capable of determining a location.

17. A system according to claim 16 further comprising a signaling device operably engaged with the location-determining device and configured to be capable of transmitting a signal, including a location signal corresponding to the location determined by the location-determining device, to a station remotely disposed with respect to the location-determining device.

18. A system according to claim 17 wherein the monitoring element further comprises a housing configured to house the location-determining device and the signaling device.

19. A system according to claim 13 wherein the monitoring element is configured to be deployable onto the monitored object from a remote location discrete with respect to the monitored object.

20. A system according to claim 13 wherein the monitoring element is further configured as a projectile having a forward end and a rearward end relative to a deployment direction, and the securing members are operably engaged with the monitoring element about the forward end thereof such that, upon deployment of the monitoring element, the unsupported distal ends of the securing members extend toward the rearward end of the monitoring element and such that, upon the forward end of the monitoring element contacting the monitored object, the unsupported distal ends of the securing members pivot about the proximal ends thereof and toward the monitored object such that the at least a medial portion of one of the securing members securingly engages the monitored object and secures the monitoring element thereto.

21. A system according to claim 16 wherein the location-determining device further comprises a Global Positioning System (GPS) device.

22. A system according to claim 17 further comprising at least one of an audio device capable of capturing an audio signal and a video device capable of capturing a video signal, the at least one of the audio and the video devices being operably engaged with the monitoring element and with the signaling device, wherein the signaling device is configured to be capable of transmitting at least one of the audio and the video signals.

23. A system according to claim 17 wherein the signaling device is further configured to be capable of receiving a signal from the station, and the monitoring device further comprises at least one of an audio device capable of broadcasting an audio signal and a video device capable of broadcasting a video signal, the at least one of the audio and the video devices being operably engaged with the monitoring element and capable of broadcasting the respective audio and video signals in response to the signal received from the station via the signaling device.

24. A system according to claim 17 wherein the signaling device is configured to be capable of communicating with the station by way of at least one of a wireless and a wireline communication system.

25. A system according to claim 13 wherein the deployment vehicle further comprises at least one of an unmanned aerial vehicle (UAV), a manned aerial vehicle, a ground vehicle, and a waterbome vehicle.

26. A system according to claim 13 further comprising a launcher device operably engaged with the deployment vehicle and configured to be capable of launching the monitoring device toward the monitored object.

27. A method of monitoring a monitored object, said method comprising:
deploying a monitoring device from a deployment vehicle onto a monitored object, the monitoring device comprising a monitoring element and a plurality of flexible elongate securing members operably engaged with the monitoring element;
securing the monitoring element to the monitored object with at least one of the securing members, each securing member having a proximal end secured to and extending from the monitoring element to an opposed unsupported distal end, such that at least a medial portion of the at least one of the securing members, between the proximal and distal ends thereof, is in securing engagement with the monitored object;
providing a monitoring indicia with the monitoring element so as to allow the monitored object to be monitored.

28. A method according to claim 27 wherein the monitoring device further comprises a location-determining device capable of producing a location signal, and a signaling device operably engaged with the location-determining device and configured to be capable of transmitting a signal, including the location signal, to a station remotely disposed with respect to the location-determining device, and wherein the method further comprises receiving the location signal from the location-determining device via the signaling device.

29. A method according to claim 28 wherein the location-determining device further comprises a Global Positioning System (GPS) device capable of producing a GPS location signal, and receiving the location signal further comprises receiving the GPS location signal from the Global Positioning System (GPS) device via the signaling device.

30. A method according to claim 28 wherein the monitoring device further comprises at least one of an audio device capable of capturing an audio signal and a video device capable of capturing a video signal, the at least one of the audio and video devices being operably engaged with the monitoring element, and the method further comprises receiving at least one of the audio and the video signals at the station via the signaling device.

31. A method according to claim 28 wherein the signaling device is further configured to be capable of receiving a signal and the method further comprises transmitting a signal from the station to the monitoring device via the signaling device.

32. A method according to claim 28 wherein the monitoring device further comprises at least one of an audio device capable of broadcasting an audio signal and a video device capable of broadcasting a video signal, the at least one of the audio and the video devices being operably engaged with the monitoring element, and the method further comprises broadcasting at least one of the audio and video signals in response to the signal received from the station via the signaling device.

33. A method according to claim 28 further comprising communicating between the monitoring device and the station via the signaling device over at least one of a wireless and a wireline communication system.

34. A method according to claim 27 wherein securing the monitoring element to the monitored object further comprises securing the monitoring element to the monitored object with at least one of the securing members, the at least one of the securing members comprising at least one of an adhesive substance and a magnetic substance.

35. A method according to claim 27 further comprising monitoring the monitored object via the monitoring indicia associated with the monitoring element, the monitoring indicia comprising at least one of a light emitter, a luminescent material, a distinctively colored material, a sound emitter, a location signal emitter, a light reflector, a sound reflector, and a radar reflector.

36. A method according to claim 27 wherein the monitoring element is further configured as a projectile having a forward end and a rearward end relative to a deployment direction, and the securing members are operably engaged with the monitoring element about the forward end thereof, and wherein deploying the monitoring device further comprises deploying the monitoring device such that the unsupported distal ends of the securing members extend toward the rearward end of the monitoring element.

37. A method according to claim 36 wherein securing the monitoring element further comprises securing the monitoring element to the monitored object by contacting the monitored object with the forward end of the monitoring element such that the unsupported distal ends of the securing members pivot about the proximal ends thereof and toward the monitored object, whereby the at least a medial portion of one of the securing members securingly engages the monitored object and secures the monitoring element thereto.

38. A system according to claim 27 wherein deploying a monitoring device from a deployment vehicle further comprises deploying a monitoring device from a deployment vehicle comprising at least one of an unmanned aerial vehicle (UAV), a manned aerial vehicle, a ground vehicle, and a waterbome vehicle.

39. A method according to claim 27 wherein deploying the monitoring device further comprises launching the monitoring device toward the monitored object with a launcher device operably engaged with the deployment vehicle.
